(19) United States
(12) Patent Application Publication
(10) Pub. No.: US 2025/0061038 A1
(43) Pub. Date: Feb. 20, 2025

(54) SYSTEM AND METHOD FOR MANAGING SOFTWARE APPLICATION PERFORMANCE

(71) Applicant: The Toronto-Dominion Bank, Toronto (CA)

(72) Inventors: Aayush KATHURIA, Brampton (CA); Periyakaruppan Subbu NARAYANAN, Mississauga (CA); Lokesh GUPTA, Brampton (CA); Vathshen MUTHURAMAN SAKUNTHALA, Kitchener (CA)

(21) Appl. No.: 18/451,475

(22) Filed: Aug. 17, 2023

(51) Int. Cl. G06F 11/34; G06F 11/30

(52) U.S. Cl. CPC G06F 11/3457; G06F 11/302; G06F 11/3409; G06F 11/3466

(57) ABSTRACT

Computing platforms, methods, and storage media for managing software application performance are disclosed. Exemplary implementations may: obtain, by a processor, an initial set of resource parameters for a software application; determine, by the processor and using a test environment, performance parameters for the software application based on observed performance parameters in a production environment; determine, by the processor and using a data model, a revised set of resource parameters for the software application to process a revised amount of resource requests greater than the initial amount of resource requests; and dynamically generate, by the processor, a resource recommendation display comprising a plurality of resource recommendation options based on the determined revised set of resource parameters.

### FIELD

The present disclosure relates to software performance management, including but not limited to computing platforms, methods, and storage media for managing software application performance.

### BACKGROUND

Software applications run in a production environment, based on a set of system requirements for meeting service levels, for example relating to application responsiveness and resource usage. In many cases, as a software application grows in adoption and popularity, the application may require additional resources to continue to meet required service levels.

When planning for future operation of a software application, it may be necessary to determine any changes that may be required to handle increased usage. If it becomes necessary to plan for a software application's significantly increased usage rate, there are no tools currently available to assist in such planning.

Improvements in approaches for managing software application performance are desirable.

### BRIEF DESCRIPTION OF THE DRAWINGS

Embodiments of the present disclosure will now be described, by way of example only, with reference to the attached Figures.

FIG. 1 illustrates a system configured for managing software application performance, in accordance with one or more embodiments.

FIG. 2 illustrates another system configured for managing software application performance, in accordance with one or more embodiments.

FIG. 3 illustrates a method for managing software application performance, in accordance with one or more embodiments.

FIG. 4 illustrates another method for managing software application performance, in accordance with one or more embodiments.

FIG. 5 illustrates an example output of a system for managing software application performance, in accordance with one or more embodiments.

### DETAILED DESCRIPTION

Computing platforms, methods, and storage media for managing software application performance are disclosed. Exemplary implementations may: obtain, by a processor, an initial set of resource parameters for a software application; determine, by the processor and using a test environment, performance parameters for the software application based on observed performance parameters in a production environment; determine, by the processor and using a data model, a revised set of resource parameters for the software application to process a revised amount of resource requests greater than the initial amount of resource requests; and dynamically generate, by the processor, a resource recommendation display comprising a plurality of resource recommendation options based on the determined revised set of resource parameters.

The present disclosure provides a platform for predicting performance and requirements of a software application under higher usage parameters than a current state.

Different tools may collect software application data in different formats. There is currently a technical problem in collecting disparate data from various sources, and combining them in a way that is helpful. Embodiments of the present disclosure provide a technical solution by providing a single platform in which resource parameters may be obtained and consolidated, to enable determination and generation of a resource recommendation display comprising a plurality of resource recommendation options.

Another issue is that test environments do not properly emulate production environments. There is a technical problem in attempting to calibrate a test environment to more accurately emulate a production environment. Embodiments of the present disclosure provide a technical solution by which a system may modify, by a processor and based on an environment scaling factor, one or more test environment parameters associated with the test environment to calibrate the test environment to accurately emulate the production environment. This overcomes issues associated with test environments that do not accurately emulate production environments.

A further issue is that there is no way to predict or determine resources that would be required for a software application to perform under different usage parameters, partly due to a technical problem in being able to characterize and calculate helpful data. Embodiments of the present disclosure provide a technical solution by providing a system and method configured to determinate and generate a resource recommendation display comprising a plurality of resource recommendation options, which may comprise a plurality of mutually exclusive resource recommendation options. While some known approaches output a set of data including a plurality of resource recommendations relating to a single option, embodiments of the present disclosure may generate and cause display of a plurality of mutually exclusive resource recommendation options. This provides a technical improvement over known approaches that may calculate a number of parameters that relate to only a single implementation option. The system may cause display of the resource recommendation options without any indication of preference, permitting an informed user to make a decision based on the displayed resource recommendation options. In another embodiment, a suggested resource recommendation indicator indicates a preferred recommendation from among the displayed plurality of resource recommendation options, for example based on calculations and determinations, including based on determined benefits or drawbacks, and also based on machine learning.

Embodiments of the present disclosure provide a system and data model for forecasting an application's behaviour based on current state data, and based on a future requirements definition. When a software application is running at a first usage rate, embodiments of the present disclosure use a data model to forecast what the future system requirements may be to run the software application at a second usage rate, higher than the first usage rate. The system may forecast infrastructure capacity, resource use and application responsiveness at the higher usage rate.

One aspect of the present disclosure relates to a computing platform configured for managing software application performance. The computing platform may include a non-transient computer-readable storage medium having executable instructions embodied thereon. The computing platform may include one or more hardware processors configured to execute the instructions. The processor(s) may execute the instructions to obtain, by a processor, an initial set of resource parameters for a software application. The initial set of resource parameters corresponding to the software application may processing an initial amount of resource requests. The processor(s) may execute the instructions to determine, by the processor and using a test environment, performance parameters for the software application based on observed performance parameters in a production environment. The processor(s) may execute the instructions to determine, by the processor and using a data model, a revised set of resource parameters for the software application to process a revised amount of resource requests greater than the initial amount of resource requests. The processor(s) may execute the instructions to dynamically generate, by the processor, a resource recommendation display including a plurality of resource recommendation options based on the determined revised set of resource parameters.

Another aspect of the present disclosure relates to a method for managing software application performance. The method may include obtaining, by a processor, an initial set of resource parameters for a software application. The initial set of resource parameters corresponding to the software application may processing an initial amount of resource requests. The method may include determining, by the processor and using a test environment, performance parameters for the software application based on observed performance parameters in a production environment. The method may include determining, by the processor and using a data model, a revised set of resource parameters for the software application to process a revised amount of resource requests greater than the initial amount of resource requests. The method may include dynamically generating, by the processor, a resource recommendation display including a plurality of resource recommendation options based on the determined revised set of resource parameters.

Yet another aspect of the present disclosure relates to a non-transient computer-readable storage medium having instructions embodied thereon, the instructions being executable by one or more processors to perform a method for managing software application performance. The method may include obtaining, by a processor, an initial set of resource parameters for a software application. The initial set of resource parameters corresponding to the software application may processing an initial amount of resource requests. The method may include determining, by the processor and using a test environment, performance parameters for the software application based on observed performance parameters in a production environment. The method may include determining, by the processor and using a data model, a revised set of resource parameters for the software application to process a revised amount of resource requests greater than the initial amount of resource requests. The method may include dynamically generating, by the processor, a resource recommendation display including a plurality of resource recommendation options based on the determined revised set of resource parameters.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

Certain terms used in this application and their meaning as used in this context are set forth in the description below. To the extent a term used herein is not defined, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

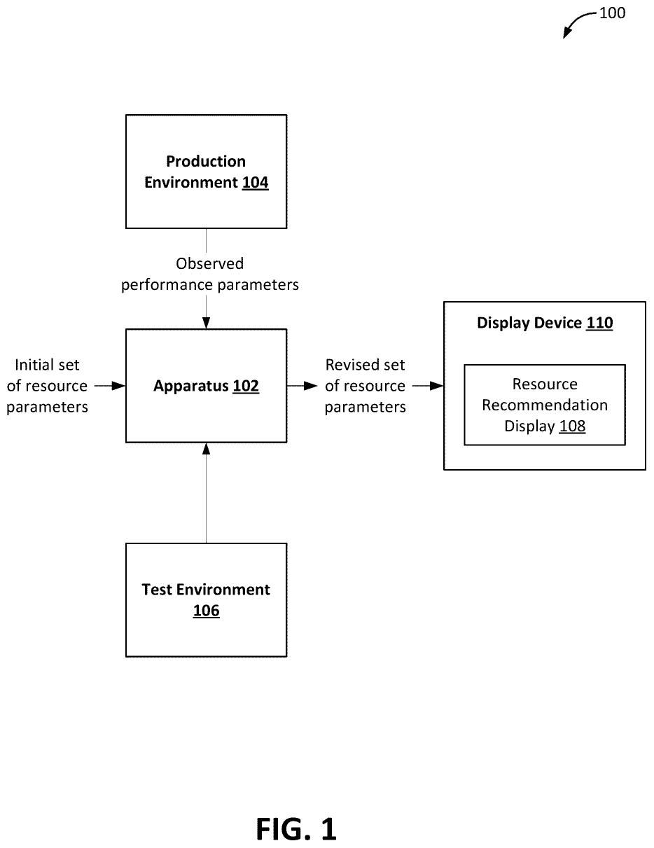

FIG. 1 illustrates a system 100 configured for managing software application performance, in accordance with one or more embodiments. The system 100 comprises an apparatus 102 in communication with a production environment 104 and a test environment 106. The apparatus 102 may be configured for managing software application performance, and may comprise a non-transient computer-readable storage medium having executable instructions embodied thereon. The apparatus 102 may comprise one or more hardware processors configured to execute the instructions to obtain an initial set of resource parameters for a software application. The initial set of resource parameters may correspond to parameters associated with the software application processing an initial amount of resource requests, for example associated with a production environment and with current demand.

The apparatus 102 may comprise one or more hardware processors configured to execute the instructions determine, in association with or using a test environment 106, performance parameters for the software application based on observed performance parameters in the production environment 104. The apparatus 102 may comprise one or more hardware processors configured to execute the instructions to determine, using a data model, a revised set of resource parameters for the software application to process a revised amount of resource requests greater than the initial amount of resource requests.

The apparatus 102 may comprise one or more hardware processors configured to execute the instructions to dynamically generate a resource recommendation display 108 comprising a plurality of resource recommendation options based on the determined revised set of resource parameters. The apparatus 102 may cause display of the resource recommendation display 108 at a display device 110. In an embodiment, the apparatus 102 may comprise one or more hardware processors configured to execute the instructions to dynamically generate resource recommendation display components comprising a plurality of resource recommendation options based on the determined revised set of resource parameters, and to cause display of the resource recommendation display components on the display device 110.

Embodiments of the present disclosure provide a method and system configured to use an analytical model to predict performance of a software application at a different usage rate, and to assess required capacity and provide recommendations. The system 100 may use a data model that obtains data from the production environment 104, and some testing results from the test environment 106. Based on those metrics, the system 100 may generate a mathematical model characterizing application behavior. Raw data from different types of tools may be provided in different formats. Embodiments of present disclosure consolidate the data and may perform prediction analysis of the data points, which may be initially segregated, to predict application behavior.

Performance may be determined based on user experience. For example, the system may determine application response time, such as to log in to the application, is about 3 seconds at 1,000 users. Embodiments of the present disclosure seek to predict how the application will behave when there are 5,000, or 10,000 users. Performance may also be determined based on resource utilization, for example infrastructure utilization, Java Virtual Machine (JVM) thread utilization, database thread utilization. This may change based on different patterns of users and activities coming into the system.

In an example scenario, consider a software application configured to accept 500,000 data transfer requests per day. Embodiments of the present disclosure may assist in answering: What parameters for the associated system 100 would be needed to be able to handle 2 million data transfers per day? This may include resource usage, and possibly scaling infrastructure horizontally or vertically. For example, if current utilization is 50%, in order to keep on the same resource utilization, is it necessary to increase the infrastructure by 2×, or by 4×? What combination of resource parameters will enable the system to handle increased volume? It is undesirable, and represents poor resource usage and planning, to blindly increase the number of resources by 4× just because number of data transfer requests increases by 4×. Embodiments of the present disclosure assist in determining a set, or a plurality of sets, of resource parameters that may be used efficiently to handle increased resource usage compared to current resource usage.

The system 100 may be configured to make determinations at multiple layers of a complex service ecosystem. The system 100 may be configured to check at each layer is it necessary to increase by 4×? Or may the system resources be optimized, so that an increase by less, such as only 2× or another factor, is sufficient? Log information may be used to provide the data points, which will be fed into the model, and will determine what type of configuration expansion is required.

In other words, the system 100 may be configured to start with a first set of resource parameters corresponding to a first set/amount of resource requests for the software application. The system 100 may be configured to determine the resource parameters that would be needed for a second set/amount of resource requests.

Some known tools may provide current or historical usage data on a limited basis, for example that the normal volumes were 500K per day. However, such known tools cannot determine or predict the server capacity that would be needed to be able to execute 2 million data transfers per day.

Embodiments of the present disclosure may also help to use resources at maximum efficiency, so as not to waste resources or computer power. The cooperation of the apparatus 110 with the production environment 104 and the test environment 106 may thus contribute to a technical solution of reducing resource use, increasing the efficiency of resource use, or decreasing computer power required, memory required, or other resource(s) required. No known tools are currently available to make recommendations for fine tuning, for example optimal configuration out of a few different configurations. In an implementation, the system 100 may provide an output or resource recommendation display 108 relating to 2 or 3 options, each with pros and cons. In an example implementation, the system produces the options, and may optionally be configured to automatically recommend the best solution, for example based on analysis of data points including benefits and drawbacks, or pros and cons.

By proactive calculation and analysis of production data, the system 100 may forecast an application's behavior/pattern using an analytical data model. The system 100 may specify current and future capacity demands using mathematical and statistical models constructed using linear and polynomial approaches based on extrapolation results from small scale test environments. In addition, the model may leverage data from standard metrics such as garbage collection (GC)/Heap to compile behavior patterns and generate non-intrusive tuning recommendations.

In various system implementations relating information technology, performance prediction may be performed using data models to estimate infrastructure capacity, resource use, and application responsiveness. A goal of such performance prediction is fulfilling future forecasts, identifying user patterns and connecting them for an optimal solution. Such an approach may be based on the following: data collection->measurement->evaluation->analysis->prediction->re-assessment->fine tuning, and repeat.

Production data, such as from the production environment 104, may be used to develop a mathematical data model. Afterwards, test data including response time, resource utilization, log information from various peak load tests may be ingested into the model, and patterns/application behavior is predicted. The test data may be from the test environment 106.

Using trend analysis, historical data may be analyzed to predict future system load. This indicates that the measurements exhibit an increasing or decreasing trend that can be statistically distinguished from random behavior. The trend analysis results in the process of constructing new data points outside a discrete set of known data points, which is known as extrapolation. Trend analysis and extrapolation based on production statistics, on the other hand, are typically predicated on the assumption that the future trend will be similar to the past.

Several strategies may employ test data for trend analysis and extrapolation to anticipate future capacity. However, in most situations, the test environment is not a perfect replica of production, introducing inaccuracy in capacity prediction.

Embodiments of the present disclosure employ a strategy based on scaling factor and growth factor to solve the issues with trend analysis and extrapolation, as well as to improve the accuracy of capacity forecasting. The scaling factor may assist in determining how the platform needs to be scaled, by correlating between test and production. The scaling factor may be calculated and fed into later determinations for the prediction. The growth factor may be used for the prediction analysis.

A scaling factor may be determined utilizing historical production data and test data for specific resource parameters (e.g., CPU, Memory, etc.) at various input load levels, resulting in a series of scaling factors at various load levels. A single scaling factor between a test environment 106 and a production environment 104 for a certain resource parameter may be obtained, which may be an average of scaling factors.

$$Scaling factor = \frac{{CPU}_{( test )} - {CPU}_{( prod )}}{input load} ;$$

where, CPU Test=CPU utilization in test environment for a value of input of load (test) CPU CPU Prod=CPU utilization in production environment for a value of input of load (prod) CPU

A growth factor may be calculated using data from the test environment 106 and the production environment 104 based on resource parameter use versus input load. The process may entail analyzing the slope of resource use trends against load in both the production and test environments 104 and 106. The trend may be linear, polynomial, power, or anything other trend characterization. Following the trend analysis, the best fit may be selected using the R-squared value.

The slope of a graph in test and production for CPU utilization may be determined as follows:

$${M}_{( test )} = {( \frac{{Y}_{CPU 2} - {Y}_{CPU 1}}{{X}_{input load 2} - {X}_{input load 1}} )}_{test} ; \\ {M}_{( prod )} = {( \frac{{Y}_{CPU 2} - {Y}_{CPU 1}}{{X}_{input load 2} - {X}_{input load 1}} )}_{prod}$$

where CPU1 and CPU2 represent the percentage CPU usage for the matching input load2 and input load1 in test and production settings, respectively.

The growth factor may be the average of the slopes in test M(test) and production M(Prod) computed above for various load values. In general, a single growth factor for test and production may be the average of the obtained growth factors.

Capacity prediction may be based on the scaling and growth factors obtained above for test and production scenarios. A capacity forecast for CPU use may be as follows. Two CPU utilization values may be determined, one based on the scaling factor and the other on the growth factor. The prediction based on the growth factor may be calculated using the straight-line equation Y=mX+C, where m represents the slope, X the load in TPS (data transfers, or transactions, per second) and Y is the CPU utilization. As a result, the CPU in production based on the growth factor may be determined.

In an embodiment, an apparatus includes one or more hardware processors configured to execute the instructions to modify, by the apparatus and based on an environment scaling factor, one or more test environment parameters associated with the test environment to calibrate the test environment to more accurately emulate the production environment.

In an embodiment, an apparatus includes one or more hardware processors configured to: determine, by the apparatus and based on the environment scaling factor and a growth factor, a capacity associated with the revised set of resource parameters for the software application to process the revised amount of resource requests; and dynamically generate, by the apparatus, a software application capacity display based on the determined software application capacity.

In an embodiment, an apparatus includes one or more hardware processors configured to: obtain, by the apparatus, historical production data and test data for a plurality of resource parameters at a plurality of input load levels to produce a plurality of individual resource scaling factors at a plurality of load levels; and determine, by the apparatus, the environment scaling factor based on the plurality of individual resource scaling factors.

Embodiments of the present disclosure may extrapolate on resource utilization pillars such as Capacity, Resource Utilization and Application Responsiveness, using an extrapolation technique as outlined herein. With the deployment signature, the system may make determinations about application behavior and platform health. Predictive models may aid in time-sensitive remedial actions and modification options in Infrastructure, Application, and Configuration. Improved performance testing accuracy may be achieved using expected behaviors, improved workload models, and lean testing cycles. Test environment calibration may be achieved to mimic production behavior.

Embodiments of the present disclosure provide a solution that may correlate data points from production and test environments and provide recommendations for platform tuning and capacity analysis. Embodiments of the present disclosure may act as a single interface for collecting, evaluating, and advising performance metrics tuning across platforms relating to infrastructure and configuration settings. The system may comprise or use a data model that is a combination of linear and polynomial models that generates a plurality of recommendations for best configuration settings, for example a plurality of concurrent or mutually exclusive recommendations.

Based on data inputs, a system according to an embodiment provides an interactive one-stop solution that may analyze and predict a platform's infrastructure behavior, configuration optimization, and application responsiveness. Embodiments of the present disclosure provide a unique and adjustable solution, in which the data model may be adjusted based on the platform's data type and architectural setup. Embodiments of the present disclosure do not use a general approach in which the system limits itself to similar output regardless of platform design/architecture or user pattern.

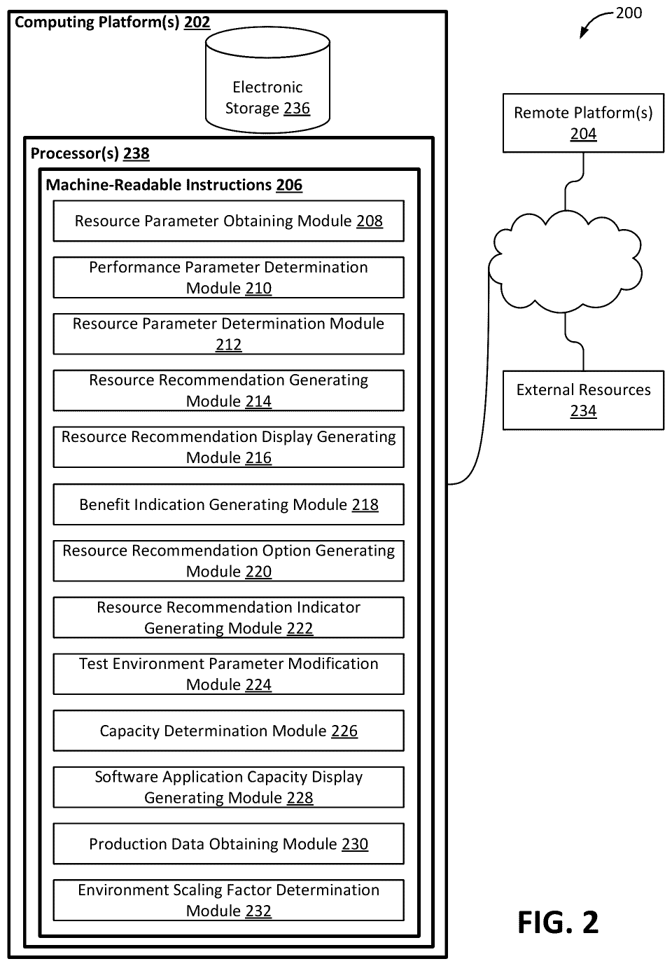

FIG. 2 illustrates a system 200 configured for managing software application performance, in accordance with one or more embodiments. In some embodiments, system 200 may include one or more computing platforms 202. Computing platform(s) 202 may be configured to communicate with one or more remote platforms 204 according to a client/server architecture, a peer-to-peer architecture, and/or other architectures. Remote platform(s) 204 may be configured to communicate with other remote platforms via computing platform(s) 202 and/or according to a client/server architecture, a peer-to-peer architecture, and/or other architectures. Users may access system 200 via remote platform(s) 204.

Computing platform(s) 202 may be configured by machine-readable instructions 206. Machine-readable instructions 206 may include one or more instruction modules. The instruction modules may include computer program modules. The instruction modules may include one or more of resource parameter obtaining module 208, performance parameter determination module 210, resource parameter determination module 212, resource recommendation generating module 214, resource recommendation display generating module 216, benefit indication generating module 218, resource recommendation option generating module 220, resource recommendation indicator generating module 222, test environment parameter modification module 224, capacity determination module 226, software application capacity display generating module 228, production data obtaining module 230, environment scaling factor determination module 232, and/or other instruction modules.

Resource parameter obtaining module 208 may be configured to obtain, by a processor, an initial set of resource parameters for a software application. The initial set of resource parameters may correspond to the software application processing an initial amount of resource requests, for example in relation to a production environment with a current resource state.

Performance parameter determination module 210 may be configured to determine, by the processor and using a test environment, performance parameters for the software application based on observed performance parameters in a production environment. Performance parameter determination module 210 may be configured to determine, by the processor and using the test environment, the performance parameters for the software application to process the revised amount of resource requests.

Resource parameter determination module 212 may be configured to determine, by the processor and using a data model, a revised set of resource parameters for the software application to process a revised amount of resource requests greater than the initial amount of resource requests. Resource parameter determination module 212 may be configured to determine the revised set of resource parameters using the data model and based on the determined performance parameters. Resource parameter determination module 212 may be configured to determine, by the processor and using the data model, first and second revised sets of resource parameters for the software application to process the revised amount of resource requests.

Resource recommendation generating module 214 may be configured to dynamically generate, by the processor, a resource recommendation display, or resource recommendation display elements, including a plurality of resource recommendation options based on the determined revised set of resource parameters. Resource recommendation display generating module 216 may be configured to dynamically generate the resource recommendation display including a concurrent display of the plurality of resource recommendation options. This is in contrast to some known approaches, which may display a plurality of resource recommendation elements that are associated with the same resource recommendation option. Resource recommendation display generating module 216 may be configured to dynamically generate the resource recommendation display including a plurality of mutually exclusive resource recommendation options.

Benefit indication generating module 218 may be configured to dynamically generate, as part of the resource recommendation display, benefit indications and drawback indications associated with the plurality of resource recommendation options. Benefit indication generating module 218 may be configured to dynamically generate, as part of the resource recommendation display, indications of infrastructure capacity, resource use and application responsiveness based on the revised amount of resource requests. Benefit indication generating module 218 may be configured to dynamically generate at least one benefit indication and at least one drawback indication associated with each of the plurality of resource recommendation options.

Resource recommendation option generating module 220 may be configured to dynamically generate, by the processor, the plurality of resource recommendation options including a first resource recommendation option based on the determined first revised set of resource parameters, and a second resource recommendation option based on the determined second revised set of resource parameters.

Resource recommendation indicator generating module 222 may be configured to dynamically generate, by the processor and based on the data model, a suggested resource recommendation indicator indicating a preferred recommendation from among the displayed plurality of resource recommendation options.

Test environment parameter modification module 224 may be configured to modify, by the processor and based on an environment scaling factor, one or more test environment parameters associated with the test environment to calibrate the test environment to accurately emulate the production environment. The calibration may be based on the calculated environment scaling factor, which may be based on underlying individual element scaling factors, and/or based on a determined growth factor, for example as further described herein.

Capacity determination module 226 may be configured to determine, by the processor and based on the environment scaling factor and a growth factor, a capacity associated with the revised set of resource parameters for the software application to process the revised amount of resource requests.

Software application capacity display generating module 228 may be configured to dynamically generate, by the processor, a software application capacity display based on the determined software application capacity.

Production data obtaining module 230 may be configured to obtain, by the processor, historical production data and test data for a plurality of resource parameters at a plurality of input load levels to produce a plurality of individual resource scaling factors at a plurality of load levels.

Environment scaling factor determination module 232 may be configured to determine, by the processor, the environment scaling factor based on the plurality of individual resource scaling factors. For example, an environment scaling factor may be considered to be a scaling factor for an entire software application environment, and determined based on scaling factors determined for individual resources. The environment scaling factor may be used to modify one or more test environment parameters associated with the test environment to calibrate the test environment to accurately emulate the production environment.

In some embodiments, computing platform(s) 202, remote platform(s) 204, and/or external resources 234 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 202, remote platform(s) 204, and/or external resources 234 may be operatively linked via some other communication media.

A given remote platform 204 may include one or more processors configured to execute computer program modules. The computer program modules may be configured to enable an expert or user associated with the given remote platform 204 to interface with system 200 and/or external resources 234, and/or provide other functionality attributed herein to remote platform(s) 204. By way of non-limiting example, a given remote platform 204 and/or a given computing platform 202 may include one or more of a server, a desktop computer, a laptop computer, a handheld computer, a tablet computing platform, a NetBook, a Smartphone, a gaming console, and/or other computing platforms.

External resources 234 may include sources of information outside of system 200, external entities participating with system 200, and/or other resources. In some embodiments, some or all of the functionality attributed herein to external resources 234 may be provided by resources included in system 200.

Computing platform(s) 202 may include electronic storage 236, one or more processors 238, and/or other components. Computing platform(s) 202 may include communication lines, or ports to enable the exchange of information with a network and/or other computing platforms. Illustration of computing platform(s) 202 in FIG. 2 is not intended to be limiting. Computing platform(s) 202 may include a plurality of hardware, software, and/or firmware components operating together to provide the functionality attributed herein to computing platform(s) 202. For example, computing platform(s) 202 may be implemented by a cloud of computing platforms operating together as computing platform(s) 202.

Electronic storage 236 may comprise non-transitory storage media that electronically stores information. The electronic storage media of electronic storage 236 may include one or both of system storage that is provided integrally (i.e., substantially non-removable) with computing platform(s) 202 and/or removable storage that is removably connectable to computing platform(s) 202 via, for example, a port (e.g., a USB port, a firewire port, etc.) or a drive (e.g., a disk drive, etc.). Electronic storage 236 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 236 may include one or more virtual storage resources (e.g., cloud storage, a virtual private network, and/or other virtual storage resources). Electronic storage 236 may store software algorithms, information determined by processor(s) 238, information received from computing platform(s) 202, information received from remote platform(s) 204, and/or other information that enables computing platform(s) 202 to function as described herein.

Processor(s) 238 may be configured to provide information processing capabilities in computing platform(s) 202. As such, processor(s) 238 may include one or more of a digital processor, an analog processor, a digital circuit designed to process information, an analog circuit designed to process information, a state machine, and/or other mechanisms for electronically processing information. Although processor(s) 238 is shown in FIG. 2 as a single entity, this is for illustrative purposes only. In some embodiments, processor(s) 238 may include a plurality of processing units. These processing units may be physically located within the same device, or processor(s) 238 may represent processing functionality of a plurality of devices operating in coordination. Processor(s) 238 may be configured to execute modules 208, 210, 212, 214, 216, 218, 218, 220, 222, 224, 226, 228, 230, and/or 232, and/or other modules. Processor(s) 238 may be configured to execute modules 208, 210, 212, 214, 216, 218, 218, 220, 222, 224, 226, 228, 230, and/or 232, and/or other modules by software; hardware; firmware; some combination of software, hardware, and/or firmware; and/or other mechanisms for configuring processing capabilities on processor(s) 238. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 208, 210, 212, 214, 216, 218, 218, 220, 222, 224, 226, 228, 230, and/or 232 are illustrated in FIG. 2 as being implemented within a single processing unit, in embodiments in which processor(s) 238 includes multiple processing units, one or more of modules 208, 210, 212, 214, 216, 218, 218, 220, 222, 224, 226, 228, 230, and/or 232 may be implemented remotely from the other modules. The description of the functionality provided by the different modules 208, 210, 212, 214, 216, 218, 218, 220, 222, 224, 226, 228, 230, and/or 232 described below is for illustrative purposes, and is not intended to be limiting, as any of modules 208, 210, 212, 214, 216, 218, 218, 220, 222, 224, 226, 228, 230, and/or 232 may provide more or less functionality than is described. For example, one or more of modules 208, 210, 212, 214, 216, 218, 218, 220, 222, 224, 226, 228, 230, and/or 232 may be eliminated, and some or all of its functionality may be provided by other ones of modules 208, 210, 212, 214, 216, 218, 218, 220, 222, 224, 226, 228, 230, and/or 232. As another example, processor(s) 238 may be configured to execute one or more additional modules that may perform some or all of the functionality attributed below to one of modules 208, 210, 212, 214, 216, 218, 218, 220, 222, 224, 226, 228, 230, and/or 232.

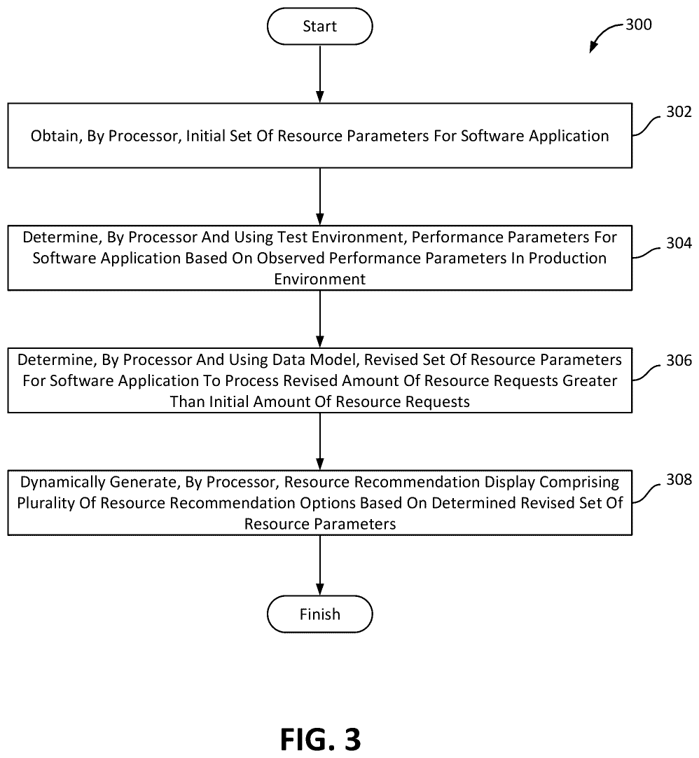

FIG. 3 illustrates a method 300 for managing software application performance, in accordance with one or more embodiments. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

An operation 302 may include obtaining, by a processor, an initial set of resource parameters for a software application. The initial set of resource parameters may correspond to the software application processing an initial amount of resource requests. Operation 302 may be performed by one or more hardware processors configured by machine-readable instructions including a module that is the same as or similar to resource parameter obtaining module 208, in accordance with one or more embodiments.

An operation 304 may include determining, by the processor and using a test environment, performance parameters for the software application based on observed performance parameters in a production environment. Operation 304 may be performed by one or more hardware processors configured by machine-readable instructions including a module that is the same as or similar to performance parameter determination module 210, in accordance with one or more embodiments.

An operation 306 may include determining, by the processor and using a data model, a revised set of resource parameters for the software application to process a revised amount of resource requests greater than the initial amount of resource requests. Operation 306 may be performed by one or more hardware processors configured by machine-readable instructions including a module that is the same as or similar to resource parameter determination module 212, in accordance with one or more embodiments.

An operation 308 may include dynamically generating, by the processor, a resource recommendation display including a plurality of resource recommendation options based on the determined revised set of resource parameters. Operation 308 may be performed by one or more hardware processors configured by machine-readable instructions including a module that is the same as or similar to resource recommendation generating module 214, in accordance with one or more embodiments.

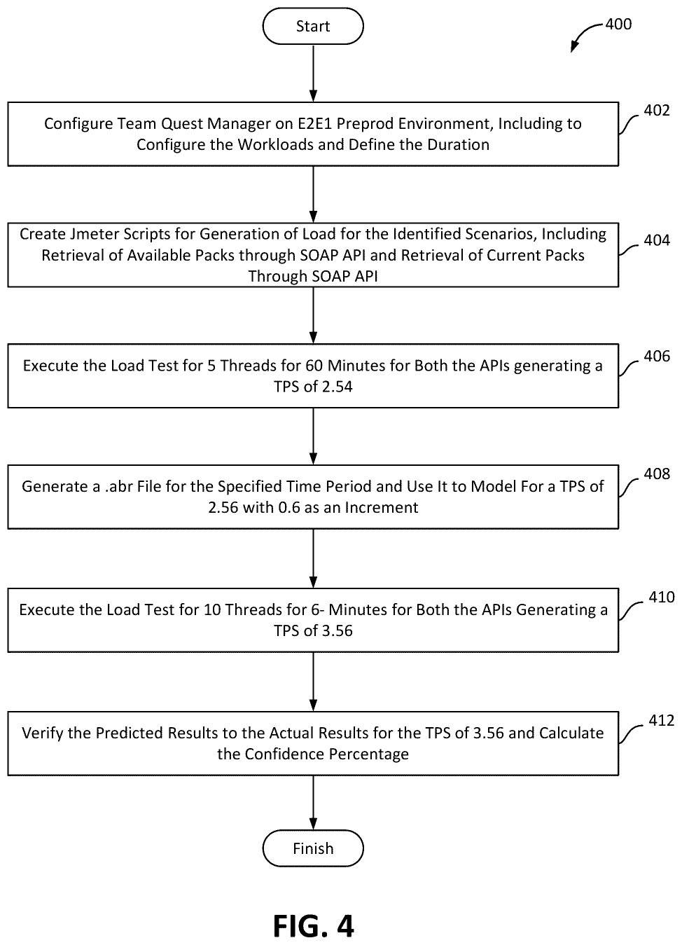

FIG. 4 illustrates another method 400 for managing software application performance, in accordance with one or more embodiments. The method 400 of FIG. 4 illustrates a specific example of aspects of the present disclosure in relation to particular parameters and scenarios. The operations of method 400 presented below are intended to be illustrative. In some embodiments, method 400 may be accomplished with one or more additional operations not described, and/or without one or more of the operations discussed. Additionally, the order in which the operations of method 400 are illustrated in FIG. 4 and described below is not intended to be limiting.

In some embodiments, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

An operation 402 may include configuring, by a processor, a TeamQuest manager on a preproduction environment, including to configure the workloads and define the duration. While a specific example is described in operation 402 in relation to TeamQuest software, in other embodiments any other capacity management solution may be used.

An operation 404 may include creating, by the processor, JMeter scripts for generation of load for the identified scenarios, including retrieval of available packs through Simple Object Access Protocol (SOAP) API and retrieval of current packs through SOAP API. While a specific example is described in operation 404 in relation to JMeter scripts and SOAP API, other approaches for recording user actions and other APIs or approaches may be used.

An operation 406 may include executing, by a processor, a load test for 5 threads for 60 minutes for both the APIs generating a TPS (transactions per second) of 2.54. While a specific example is described in operation 406 in relation to a load test and generating a transactions per second value, in other embodiments any other load test for any amount of threads or duration may be used in relation to any performance parameter. The values used in operation 406 may be an initial set of resource parameters.

An operation 408 may include generating, by a processor, a .abr file (Adobe Photoshop brush file) for the specified time period and using it to model for a TPS of 2.56 with 0.6 as an increment. While a specific example is described in operation 408 in relation to a specific output file used to model for a specific TPS value with a particular increment, in other embodiments any model may be used to model any performance parameter using a suitable increment.

An operation 410 may include executing, by a processor, a load test for 10 threads for 6 minutes for both the APIs generating a TPS of 3.56. The values used in operation 410 may be described as a revised set of resource parameters, similar to how the values used in operation 406 may be described as an initial set of resource parameters. While a specific example is described in operation 410 in relation to a load test and generating a transactions per second value, in other embodiments any other load test for any amount of threads or duration may be used in relation to any performance parameter.

An operation 412 may include verifying, by a processor, the predicted results compared to the actual results for the TPS of 3.56 and calculating the confidence percentage. The operation 412 may be associated with test environment parameter modification, where one or more test environment parameters associated with the test environment are modified based on an environment scaling factor to calibrate the test environment to accurately emulate the production environment. The operation 412 may assist in determining whether the test environment has been properly calibrated, or whether further calibration is required. While a specific example is described in operation 412 in relation to comparing predicted results to actual results and calculating a confidence percentage, in other embodiments any other comparison of test and production data may be used in relation to any performance parameter and in relation to calculating a measure of proper calibration of a test environment to a production environment.

Operations 402, 404, 406, 408, 410 and 412 may be performed by one or more hardware processors configured by machine-readable instructions, for example including a module that is the same as or similar to modules described or illustrated herein, in accordance with one or more embodiments.

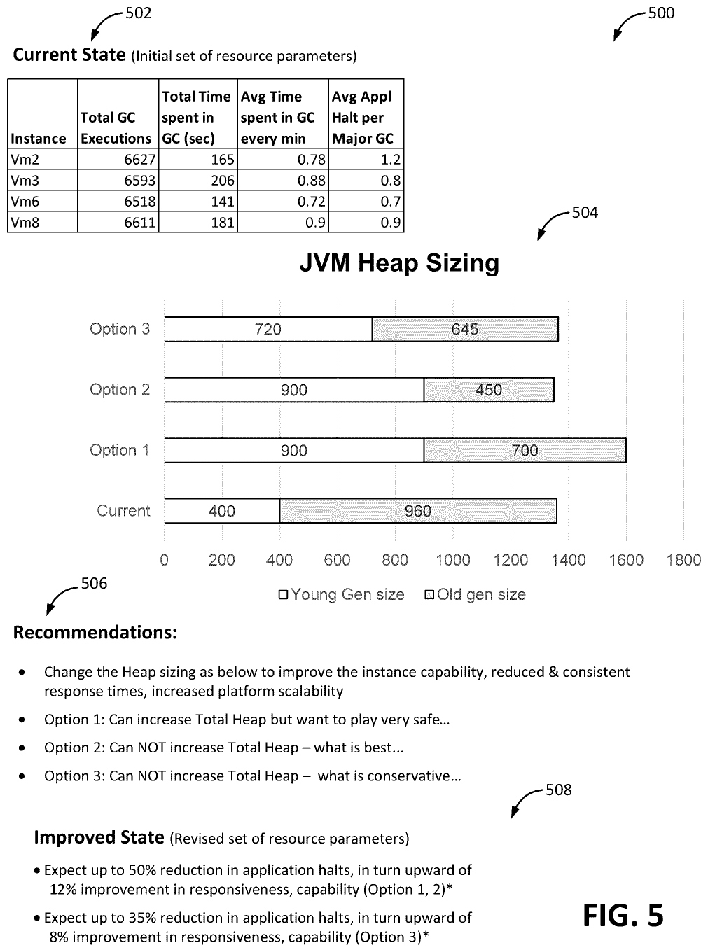

FIG. 5 illustrates an example output 500 of a system for managing software application performance, in accordance with one or more embodiments. The embodiment of FIG. 5 relates to an example in which a system uses a data model in order to predict the performance with respect to garbage collection (GC). Garbage collection is a process or mechanism used by a software application to help maintain and manage the application's use of memory in an optimal way. GC can run so that memory that is not utilized by the application at runtime will be freed at regular intervals and periods. When GC runs, it typically pauses the whole application such that none of the application's activities can happen, making it important to keep GC optimized so that the amount of application downtime is reduced or minimized. GC is often used by Java applications, which are hosted on Java Virtual Machine Software (JVMS).

Embodiments of the present disclosure may be configured to perform non-intrusive tuning, where fine tuning of the application parameters does not interfere with the application itself. The system may analyze a plurality of configuration parameters and determine whether there is a scope for any improvement. For example, one analysis was performed with respect to garbage collection parameters for a mobile application, such as a mobile banking application.

In the embodiment of FIG. 5, the output may comprise a current state output 502 comprises resource data associated with a current state in relation to which software application performance is being managed, which in this case includes garbage collection (GC). The current state may be in association with an initial set of resource parameters. In certain embodiments, the output may omit information such as 502 relating to the current state, and focus on the improved state and associated recommendations.

The output 500 may comprise a resource recommendation display 504 comprising a plurality of resource recommendation options based on the determined revised set of resource parameters. The system may dynamically generate the resource recommendation display comprising a plurality of mutually exclusive resource recommendation options, as shown in FIG. 5. While some known approaches output a set of data including a plurality of resource recommendations relating to a single option, embodiments of the present disclosure may generate and cause display of a plurality of mutually exclusive resource recommendation options, as shown at 504. This provides an improvement over known approaches that may calculate a number of parameters that relate to a single implementation option.

For each garbage collection, there are two types of memory: young gen and old gen. The example output 504 indicates a current configuration or initial set of resource parameters of 400 MB for young gen size and 960 MB for old gen size. According to embodiments of the present disclosure, an apparatus may be configured to: determine, by the apparatus and using a test environment, performance parameters for the software application based on observed performance parameters in a production environment; determine, by the apparatus and using a data model, a revised set of resource parameters for the software application to process a revised amount of resource requests greater than the initial amount of resource requests; and dynamically generate, by the apparatus, a resource recommendation display comprising a plurality of resource recommendation options based on the determined revised set of resource parameters.

In the example embodiment of FIG. 5, the output 504 comprises 3 resource recommendation options. According to Option 1, the young gen size is increased to 900 MB, and the old gen size is decreased to 700 MB, with cost of an overall memory increase to a total of about 1600 MB, compared to the current/initial set of resource parameters of about 1360 MB. Option 2 has about the same overall memory at 1350 MB (a slight decrease from 1360 MB), with a similar increase of the young gen size to 900 MB, and a decrease of old gen to 450 MB, effectively changing the ratio of young/old gen compared to the initial set of resources. Option 3 has about the same overall memory at 1365 MB (a slight increase from 1360 MB), with a more even distribution between an increased young gen size of 720 MB, and old gen of 645 MB.

In an example implementation, an apparatus according to the present disclosure comprises one or more hardware processors configured to execute instructions to determine, by the apparatus and using a data model, first and second revised sets of resource parameters for the software application to process the revised amount of resource requests.

These revised sets of resource parameters may be associated with different recommendation options. In the example of FIG. 5, three different recommendation options are provided, the three options being associated with first, second and third revised sets of resource parameters. In an example implementation, an apparatus according to the present disclosure comprises one or more hardware processors configured to execute instructions to dynamically generate, by the apparatus, the plurality of resource recommendation options comprising a first resource recommendation option based on the determined first revised set of resource parameters, and a second resource recommendation option based on the determined second revised set of resource parameters.

The output may comprise, as part of the resource recommendation display, benefit indications and drawback indications associated with the plurality of resource recommendation options, such as shown at 506 and 508. For example, the resource recommendation display may comprise benefit indications and drawback indications associated with the plurality of resource recommendation options.

The output may comprise an improved state output 508 comprising resource performance details associated with a revised state in relation to which software application performance is being managed. The improved state may be in association with a revised set of resource parameters that is higher than, or is associated with a higher performance than, the initial set of resource parameters. In the example of FIG. 5, the improved state output 504 comprises performance characteristics associated with one or more resource recommendation options. For example, first resource performance details indicate, in association with Options 1 and 2, an expectation of up to 50% reduction in application halts, and in turn upward of a 12% improvement in responsiveness, capability. Second resource performance details indicate, in association with Option 3, an expectation of up to 35% reduction in application halts, and in turn upward of an 8% improvement in responsiveness, capability.

In an embodiment, the system may cause display of the three resource recommendation options without any indication of preference. This permits an informed user to make a decision based on the displayed resource recommendation options. In another embodiment, the processor(s) may be configured to dynamically generate, by the processor and based on the data model, a suggested resource recommendation indicator indicating a preferred recommendation from among the displayed plurality of resource recommendation options. The preferred recommendation may be indicated based on calculations and determinations made by the apparatus, for example based on benefits or drawbacks, and also based on machine learning. For example, Option 1 may be discarded or omitted from consideration given that it results in an increase in required resources, is not a cost-effective solution; Option 2 does not have an increase in resources. Between Option 2 and Option 3, the outputs 506 and 508 indicate that Option 2 provides a higher reduction in application halts, and a higher improvement in responsiveness and capability, at a similar resource cost. Accordingly, in an example embodiment, a preferred recommendation may be indicated in association with Option 2.

The present disclosure provides a platform for predicting performance and requirements of a software application under higher usage parameters than a current state. Embodiments of the present disclosure provide a system and data model for forecasting an application's behaviour based on current state data, and based on a future requirements definition. When a software application is running at a first usage rate, embodiments of the present disclosure use a data model to forecast what the future system requirements may be to run the software application at a second usage rate, higher than the first usage rate. The system may forecast infrastructure capacity, resource use and application responsiveness at the higher usage rate.

Embodiments of the present disclosure may comprise an extrapolation model that includes an analytical dimension, a mathematical dimension, and an artificial intelligence/machine learning (AI/ML) dimension. Modeling techniques may be tool based, such as using TeamQuest. Analytical/mathematical modeling may be based on linear regression and/or polynomial curves. AI/ML learning may be based on a self-explanatory model, in which various “what if” scenarios are defined with respect to a tool such as Tableau, and a platform-specific approach/method is developed. An approach according to embodiments of the present disclosure may represent interplay behaviour of production modulo interfaces and integrations. The approach may provide user/data transfer scaling modeling and prediction and/or hardware scaling modeling and prediction, beginning with measurement to inform the prediction. Benefits of embodiments of the present disclosure may include cutting down cycle times and costs, and allowing for a variety of extrapolations closer to production.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a compact disk read only memory (CD-ROM), digital versatile disk (DVD), Blu-ray Disc Read Only Memory (BD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

Embodiments of the disclosure can be described with reference to the following clauses, with specific features laid out in the dependent clauses:

One aspect of the present disclosure relates to a system configured for managing software application performance. The system may include one or more hardware processors configured by machine-readable instructions. The processor(s) may be configured to obtain, by a processor, an initial set of resource parameters for a software application. The initial set of resource parameters corresponding to the software application may processing an initial amount of resource requests. The processor(s) may be configured to determine, by the processor and using a test environment, performance parameters for the software application based on observed performance parameters in a production environment. The processor(s) may be configured to determine, by the processor and using a data model, a revised set of resource parameters for the software application to process a revised amount of resource requests greater than the initial amount of resource requests. The processor(s) may be configured to dynamically generate, by the processor, a resource recommendation display including a plurality of resource recommendation options based on the determined revised set of resource parameters.

In some implementations of the system, the processor(s) may be configured to dynamically generate the resource recommendation display including a concurrent display of the plurality of resource recommendation options.

In some implementations of the system, the processor(s) may be configured to determine the revised set of resource parameters using the data model and based on the determined performance parameters.

In some implementations of the system, the processor(s) may be configured to determine, by the processor and using the test environment, the performance parameters for the software application to process the revised amount of resource requests.

In some implementations of the system, the processor(s) may be configured to dynamically generate the resource recommendation display including a plurality of mutually exclusive resource recommendation options.

In some implementations of the system, the processor(s) may be configured to dynamically generate, as part of the resource recommendation display, benefit indications and drawback indications associated with the plurality of resource recommendation options.

In some implementations of the system, the processor(s) may be configured to dynamically generate at least one benefit indication and at least one drawback indication associated with each of the plurality of resource recommendation options.

In some implementations of the system, the processor(s) may be configured to determine, by the processor and using the data model, first and second revised sets of resource parameters for the software application to process the revised amount of resource requests. In some implementations of the system, the processor(s) may be configured to dynamically generate, by the processor, the plurality of resource recommendation options including a first resource recommendation option based on the determined first revised set of resource parameters, and a second resource recommendation option based on the determined second revised set of resource parameters.

In some implementations of the system, the processor(s) may be configured to dynamically generate, by the processor and based on the data model, a suggested resource recommendation indicator indicating a preferred recommendation from among the displayed plurality of resource recommendation options.

In some implementations of the system, the processor(s) may be configured to dynamically generate, as part of the resource recommendation display, indications of infrastructure capacity, resource use and application responsiveness based on the revised amount of resource requests.

In some implementations of the system, the processor(s) may be configured to modify, by the processor and based on an environment scaling factor, one or more test environment parameters associated with the test environment to calibrate the test environment to accurately emulate the production environment.

In some implementations of the system, the processor(s) may be configured to determine, by the processor and based on the environment scaling factor and a growth factor, a capacity associated with the revised set of resource parameters for the software application to process the revised amount of resource requests. In some implementations of the system, the processor(s) may be configured to dynamically generate, by the processor, a software application capacity display based on the determined software application capacity.

In some implementations of the system, the processor(s) may be configured to obtain, by the processor, historical production data and test data for a plurality of resource parameters at a plurality of input load levels to produce a plurality of individual resource scaling factors at a plurality of load levels. In some implementations of the system, the processor(s) may be configured to determine, by the processor, the environment scaling factor based on the plurality of individual resource scaling factors.

Another aspect of the present disclosure relates to a method for managing software application performance. The method may include obtaining, by a processor, an initial set of resource parameters for a software application. The initial set of resource parameters corresponding to the software application may processing an initial amount of resource requests. The method may include determining, by the processor and using a test environment, performance parameters for the software application based on observed performance parameters in a production environment. The method may include determining, by the processor and using a data model, a revised set of resource parameters for the software application to process a revised amount of resource requests greater than the initial amount of resource requests. The method may include dynamically generating, by the processor, a resource recommendation display including a plurality of resource recommendation options based on the determined revised set of resource parameters.

In some implementations of the method, it may include dynamically generating the resource recommendation display including a concurrent display of the plurality of resource recommendation options.

In some implementations of the method, it may include determining the revised set of resource parameters using the data model and based on the determined performance parameters.

In some implementations of the method, it may include determining, by the processor and using the test environment, the performance parameters for the software application to process the revised amount of resource requests.

In some implementations of the method, it may include dynamically generating the resource recommendation display including a plurality of mutually exclusive resource recommendation options.

In some implementations of the method, it may include dynamically generating, as part of the resource recommendation display, benefit indications and drawback indications associated with the plurality of resource recommendation options.

In some implementations of the method, it may include dynamically generating at least one benefit indication and at least one drawback indication associated with each of the plurality of resource recommendation options.

In some implementations of the method, it may include determining, by the processor and using the data model, first and second revised sets of resource parameters for the software application to process the revised amount of resource requests. In some implementations of the method, it may include dynamically generating, by the processor, the plurality of resource recommendation options including a first resource recommendation option based on the determined first revised set of resource parameters, and a second resource recommendation option based on the determined second revised set of resource parameters.

In some implementations of the method, it may include dynamically generating, by the processor and based on the data model, a suggested resource recommendation indicator indicating a preferred recommendation from among the displayed plurality of resource recommendation options.

In some implementations of the method, it may include dynamically generating, as part of the resource recommendation display, indications of infrastructure capacity, resource use and application responsiveness based on the revised amount of resource requests.

In some implementations of the method, it may include modifying, by the processor and based on an environment scaling factor, one or more test environment parameters associated with the test environment to calibrate the test environment to accurately emulate the production environment.

In some implementations of the method, it may include determining, by the processor and based on the environment scaling factor and a growth factor, a capacity associated with the revised set of resource parameters for the software application to process the revised amount of resource requests. In some implementations of the method, it may include dynamically generating, by the processor, a software application capacity display based on the determined software application capacity.

In some implementations of the method, it may include obtaining, by the processor, historical production data and test data for a plurality of resource parameters at a plurality of input load levels to produce a plurality of individual resource scaling factors at a plurality of load levels. In some implementations of the method, it may include determining, by the processor, the environment scaling factor based on the plurality of individual resource scaling factors.

Yet another aspect of the present disclosure relates to a non-transient computer-readable storage medium having instructions embodied thereon, the instructions being executable by one or more processors to perform a method for managing software application performance. The method may include obtaining, by a processor, an initial set of resource parameters for a software application. The initial set of resource parameters corresponding to the software application may processing an initial amount of resource requests. The method may include determining, by the processor and using a test environment, performance parameters for the software application based on observed performance parameters in a production environment. The method may include determining, by the processor and using a data model, a revised set of resource parameters for the software application to process a revised amount of resource requests greater than the initial amount of resource requests. The method may include dynamically generating, by the processor, a resource recommendation display including a plurality of resource recommendation options based on the determined revised set of resource parameters.

In some implementations of the computer-readable storage medium, the method may include dynamically generating the resource recommendation display including a concurrent display of the plurality of resource recommendation options.

In some implementations of the computer-readable storage medium, the method may include determining the revised set of resource parameters using the data model and based on the determined performance parameters.

In some implementations of the computer-readable storage medium, the method may include determining, by the processor and using the test environment, the performance parameters for the software application to process the revised amount of resource requests.

In some implementations of the computer-readable storage medium, the method may include dynamically generating the resource recommendation display including a plurality of mutually exclusive resource recommendation options.

In some implementations of the computer-readable storage medium, the method may include dynamically generating, as part of the resource recommendation display, benefit indications and drawback indications associated with the plurality of resource recommendation options.

In some implementations of the computer-readable storage medium, the method may include dynamically generating at least one benefit indication and at least one drawback indication associated with each of the plurality of resource recommendation options.

In some implementations of the computer-readable storage medium, the method may include determining, by the processor and using the data model, first and second revised sets of resource parameters for the software application to process the revised amount of resource requests. In some implementations of the computer-readable storage medium, the method may include dynamically generating, by the processor, the plurality of resource recommendation options including a first resource recommendation option based on the determined first revised set of resource parameters, and a second resource recommendation option based on the determined second revised set of resource parameters.

In some implementations of the computer-readable storage medium, the method may include dynamically generating, by the processor and based on the data model, a suggested resource recommendation indicator indicating a preferred recommendation from among the displayed plurality of resource recommendation options.

In some implementations of the computer-readable storage medium, the method may include dynamically generating, as part of the resource recommendation display, indications of infrastructure capacity, resource use and application responsiveness based on the revised amount of resource requests.

In some implementations of the computer-readable storage medium, the method may include modifying, by the processor and based on an environment scaling factor, one or more test environment parameters associated with the test environment to calibrate the test environment to accurately emulate the production environment.

In some implementations of the computer-readable storage medium, the method may include determining, by the processor and based on the environment scaling factor and a growth factor, a capacity associated with the revised set of resource parameters for the software application to process the revised amount of resource requests. In some implementations of the computer-readable storage medium, the method may include dynamically generating, by the processor, a software application capacity display based on the determined software application capacity.

In some implementations of the computer-readable storage medium, the method may include obtaining, by the processor, historical production data and test data for a plurality of resource parameters at a plurality of input load levels to produce a plurality of individual resource scaling factors at a plurality of load levels. In some implementations of the computer-readable storage medium, the method may include determining, by the processor, the environment scaling factor based on the plurality of individual resource scaling factors.

Still another aspect of the present disclosure relates to a system configured for managing software application performance. The system may include means for obtaining, by a processor, an initial set of resource parameters for a software application. The initial set of resource parameters corresponding to the software application may processing an initial amount of resource requests. The system may include means for determining, by the processor and using a test environment, performance parameters for the software application based on observed performance parameters in a production environment. The system may include means for determining, by the processor and using a data model, a revised set of resource parameters for the software application to process a revised amount of resource requests greater than the initial amount of resource requests. The system may include means for dynamically generating, by the processor, a resource recommendation display including a plurality of resource recommendation options based on the determined revised set of resource parameters.

In some implementations of the system, the system may include means for dynamically generating the resource recommendation display including a concurrent display of the plurality of resource recommendation options.

In some implementations of the system, the system may include means for determining the revised set of resource parameters using the data model and based on the determined performance parameters.

In some implementations of the system, the system may include means for determining, by the processor and using the test environment, the performance parameters for the software application to process the revised amount of resource requests.

In some implementations of the system, the system may include means for dynamically generating the resource recommendation display including a plurality of mutually exclusive resource recommendation options.

In some implementations of the system, the system may include means for dynamically generating, as part of the resource recommendation display, benefit indications and drawback indications associated with the plurality of resource recommendation options.

In some implementations of the system, the system may include means for dynamically generating at least one benefit indication and at least one drawback indication associated with each of the plurality of resource recommendation options.

In some implementations of the system, the system may include means for determining, by the processor and using the data model, first and second revised sets of resource parameters for the software application to process the revised amount of resource requests. In some implementations of the system, the system may include means for dynamically generating, by the processor, the plurality of resource recommendation options including a first resource recommendation option based on the determined first revised set of resource parameters, and a second resource recommendation option based on the determined second revised set of resource parameters.

In some implementations of the system, the system may include means for dynamically generating, by the processor and based on the data model, a suggested resource recommendation indicator indicating a preferred recommendation from among the displayed plurality of resource recommendation options.

In some implementations of the system, the system may include means for dynamically generating, as part of the resource recommendation display, indications of infrastructure capacity, resource use and application responsiveness based on the revised amount of resource requests.

In some implementations of the system, the system may include means for modifying, by the processor and based on an environment scaling factor, one or more test environment parameters associated with the test environment to calibrate the test environment to accurately emulate the production environment.

In some implementations of the system, the system may include means for determining, by the processor and based on the environment scaling factor and a growth factor, a capacity associated with the revised set of resource parameters for the software application to process the revised amount of resource requests. In some implementations of the system, the system may include means for dynamically generating, by the processor, a software application capacity display based on the determined software application capacity.

In some implementations of the system, the system may include means for obtaining, by the processor, historical production data and test data for a plurality of resource parameters at a plurality of input load levels to produce a plurality of individual resource scaling factors at a plurality of load levels. In some implementations of the system, the system may include means for determining, by the processor, the environment scaling factor based on the plurality of individual resource scaling factors.

Even another aspect of the present disclosure relates to a computing platform configured for managing software application performance. The computing platform may include a non-transient computer-readable storage medium having executable instructions embodied thereon. The computing platform may include one or more hardware processors configured to execute the instructions. The processor(s) may execute the instructions to obtain, by a processor, an initial set of resource parameters for a software application. The initial set of resource parameters corresponding to the software application may processing an initial amount of resource requests. The processor(s) may execute the instructions to determine, by the processor and using a test environment, performance parameters for the software application based on observed performance parameters in a production environment. The processor(s) may execute the instructions to determine, by the processor and using a data model, a revised set of resource parameters for the software application to process a revised amount of resource requests greater than the initial amount of resource requests. The processor(s) may execute the instructions to dynamically generate, by the processor, a resource recommendation display including a plurality of resource recommendation options based on the determined revised set of resource parameters.

In some implementations of the computing platform, the processor(s) may execute the instructions to dynamically generate the resource recommendation display including a concurrent display of the plurality of resource recommendation options.

In some implementations of the computing platform, the processor(s) may execute the instructions to determine the revised set of resource parameters using the data model and based on the determined performance parameters.

In some implementations of the computing platform, the processor(s) may execute the instructions to determine, by the processor and using the test environment, the performance parameters for the software application to process the revised amount of resource requests.

In some implementations of the computing platform, the processor(s) may execute the instructions to dynamically generate the resource recommendation display including a plurality of mutually exclusive resource recommendation options.

In some implementations of the computing platform, the processor(s) may execute the instructions to dynamically generate, as part of the resource recommendation display, benefit indications and drawback indications associated with the plurality of resource recommendation options.

In some implementations of the computing platform, the processor(s) may execute the instructions to dynamically generate at least one benefit indication and at least one drawback indication associated with each of the plurality of resource recommendation options.

In some implementations of the computing platform, the processor(s) may execute the instructions to determine, by the processor and using the data model, first and second revised sets of resource parameters for the software application to process the revised amount of resource requests. In some implementations of the computing platform, the processor(s) may execute the instructions to dynamically generate, by the processor, the plurality of resource recommendation options including a first resource recommendation option based on the determined first revised set of resource parameters, and a second resource recommendation option based on the determined second revised set of resource parameters.

In some implementations of the computing platform, the processor(s) may execute the instructions to dynamically generate, by the processor and based on the data model, a suggested resource recommendation indicator indicating a preferred recommendation from among the displayed plurality of resource recommendation options.

In some implementations of the computing platform, the processor(s) may execute the instructions to dynamically generate, as part of the resource recommendation display, indications of infrastructure capacity, resource use and application responsiveness based on the revised amount of resource requests.

In some implementations of the computing platform, the processor(s) may execute the instructions to modify, by the processor and based on an environment scaling factor, one or more test environment parameters associated with the test environment to calibrate the test environment to accurately emulate the production environment.

In some implementations of the computing platform, the processor(s) may execute the instructions to determine, by the processor and based on the environment scaling factor and a growth factor, a capacity associated with the revised set of resource parameters for the software application to process the revised amount of resource requests. In some implementations of the computing platform, the processor(s) may execute the instructions to dynamically generate, by the processor, a software application capacity display based on the determined software application capacity.

In some implementations of the computing platform, the processor(s) may execute the instructions to obtain, by the processor, historical production data and test data for a plurality of resource parameters at a plurality of input load levels to produce a plurality of individual resource scaling factors at a plurality of load levels. In some implementations of the computing platform, the processor(s) may execute the instructions to determine, by the processor, the environment scaling factor based on the plurality of individual resource scaling factors.

1. An apparatus configured for managing software application performance, the apparatus comprising:
a non-transient computer-readable storage medium having executable instructions embodied thereon; and
one or more hardware processors configured to execute the instructions to:
obtain, by the apparatus, an initial set of resource parameters for a software application, the initial set of resource parameters corresponding to the software application processing an initial amount of resource requests;
determine, by the apparatus and using a test environment, performance parameters for the software application based on observed performance parameters in a production environment;
determine, by the apparatus and using a data model, a revised set of resource parameters for the software application to process a revised amount of resource requests greater than the initial amount of resource requests; and
dynamically generate, by the apparatus, a resource recommendation display comprising a plurality of resource recommendation options based on the determined revised set of resource parameters.

2. The apparatus of claim 1 wherein the one or more hardware processors are further configured to execute the instructions to:
dynamically generate the resource recommendation display comprising a plurality of mutually exclusive resource recommendation options.

3. The apparatus of claim 1 wherein the one or more hardware processors are further configured to execute the instructions to:
dynamically generate, as part of the resource recommendation display, benefit indications and drawback indications associated with the plurality of resource recommendation options.

4. The apparatus of claim 1 wherein the one or more hardware processors are further configured to execute the instructions to:
determine, by the apparatus and using the data model, first and second revised sets of resource parameters for the software application to process the revised amount of resource requests; and
dynamically generate, by the apparatus, the plurality of resource recommendation options comprising a first resource recommendation option based on the determined first revised set of resource parameters, and a second resource recommendation option based on the determined second revised set of resource parameters.

5. The apparatus of claim 1 wherein the one or more hardware processors are further configured to execute the instructions to:
dynamically generate, as part of the resource recommendation display, benefit indications and drawback indications associated with the plurality of resource recommendation options.

6. The apparatus of claim 1 wherein the one or more hardware processors are further configured to execute the instructions to:
dynamically generate, as part of the resource recommendation display, indications of infrastructure capacity, resource use and application responsiveness based on the revised amount of resource requests.

7. The apparatus of claim 1 wherein the one or more hardware processors are further configured to execute the instructions to:
modify, by the apparatus and based on an environment scaling factor, one or more test environment parameters associated with the test environment to calibrate the test environment to more accurately emulate the production environment.

8. The apparatus of claim 1 wherein the one or more hardware processors are further configured to execute the instructions to:
determine, by the apparatus and based on the environment scaling factor and a growth factor, a capacity associated with the revised set of resource parameters for the software application to process the revised amount of resource requests; and
dynamically generate, by the apparatus, a software application capacity display based on the determined software application capacity.

9. The apparatus of claim 1 wherein the one or more hardware processors are further configured to execute the instructions to:
obtain, by the apparatus, historical production data and test data for a plurality of resource parameters at a plurality of input load levels to produce a plurality of individual resource scaling factors at a plurality of load levels; and
determine, by the apparatus, the environment scaling factor based on the plurality of individual resource scaling factors.

10. A processor-implemented method of managing software application performance, the method comprising:
obtaining, by a processor, an initial set of resource parameters for a software application, the initial set of resource parameters corresponding to the software application processing an initial amount of resource requests;
determining, by the processor and using a test environment, performance parameters for the software application based on observed performance parameters in a production environment;
determining, by the processor and using a data model, a revised set of resource parameters for the software application to process a revised amount of resource requests greater than the initial amount of resource requests; and
dynamically generating, by the processor, a resource recommendation display comprising a plurality of resource recommendation options based on the determined revised set of resource parameters.

11. The method of claim 10 further comprising:
dynamically generating the resource recommendation display comprising a plurality of mutually exclusive resource recommendation options.

12. The method of claim 10 further comprising:
dynamically generating, as part of the resource recommendation display, benefit indications and drawback indications associated with the plurality of resource recommendation options.

13. The method of claim 10 further comprising:
dynamically generating, as part of the resource recommendation display, indications of infrastructure capacity, resource use and application responsiveness based on the revised amount of resource requests.

14. The method of claim 10 further comprising:
determining, by the processor and using the data model, first and second revised sets of resource parameters for the software application to process the revised amount of resource requests; and
dynamically generating, by the processor, the plurality of resource recommendation options comprising a first resource recommendation option based on the determined first revised set of resource parameters, and a second resource recommendation option based on the determined second revised set of resource parameters.

15. The method of claim 10 further comprising:
dynamically generating, by the processor and based on the data model, a suggested resource recommendation indicator indicating a preferred recommendation from among the displayed plurality of resource recommendation options.

16. The method of claim 10 further comprising:
modifying, by the processor and based on an environment scaling factor, one or more test environment parameters associated with the test environment to calibrate the test environment to accurately emulate the production environment.

17. The method of claim 16 further comprising:
determining, by the processor and based on the environment scaling factor and a growth factor, a capacity associated with the revised set of resource parameters for the software application to process the revised amount of resource requests; and
dynamically generating, by the processor, a software application capacity display based on the determined software application capacity.

18. The method of claim 16 further comprising:
obtaining, by the processor, historical production data and test data for a plurality of resource parameters at a plurality of input load levels to produce a plurality of individual resource scaling factors at a plurality of load levels; and
determining, by the processor, the environment scaling factor based on the plurality of individual resource scaling factors.

19. A non-transient computer-readable storage medium having instructions embodied thereon, the instructions being executable by one or more processors to perform a method for managing software application performance, the method comprising:
obtaining, by the one or more processors, an initial set of resource parameters for a software application, the initial set of resource parameters corresponding to the software application processing an initial amount of resource requests;
determining, by the one or more processors and using a test environment, performance parameters for the software application based on observed performance parameters in a production environment;
determining, by the one or more processors and using a data model, a revised set of resource parameters for the software application to process a revised amount of resource requests greater than the initial amount of resource requests; and
dynamically generating, by the one or more processors, a resource recommendation display comprising a plurality of resource recommendation options based on the determined revised set of resource parameters.

20. The non-transient computer-readable storage medium of claim 19 wherein the method further comprises:
determining, by the one or more processors and using the data model, first and second revised sets of resource parameters for the software application to process the revised amount of resource requests; and
dynamically generating, by the one or more processors, the plurality of resource recommendation options comprising a first resource recommendation option based on the determined first revised set of resource parameters, and a second resource recommendation option based on the determined second revised set of resource parameters.
